(19) United States
(12) Patent Application Publication
(10) Pub. No.: US 2003/0208629 A1
(43) Pub. Date: Nov. 6, 2003

(54) Wireless network connection apparatus and method for portable computers

(76) Inventor: David S. Parkman, Mercer Island, WA (US)

Correspondence Address: HARNESS, DICKEY & PIERCE, P.L.C., P.O. BOX 828, BLOOMFIELD HILLS, MI, 48303, US

(21) Appl. No.: 09/965,548

(22) Filed: Sep. 27, 2001

(51) Int. Cl. G06F 15/16

(52) U.S. Cl. 709/250

(57) ABSTRACT

A wireless connectivity device is provided for connecting a computing device to a wireless network onboard an aircraft. The wireless connectivity device converts a networking signal received from the computing device into a standardized format for sending to a wireless networking interface card. The wireless network interface card is disposed within the wireless connectivity device. In a preferred embodiment the wireless connectivity device is powered by a rechargeable battery disposed within the housing of the wireless connectivity device. In a second preferred embodiment, the wireless connectivity device is powered by a second connection to a USB port disposed within the computing device. In a third preferred embodiment, a networking signal is received from a networking port in the computing device and converted to a wireless signal for connectivity to a wireless network. In the third preferred embodiment, the circuitry of the wireless network interface card is integrated into the wireless connectivity device without the necessity of a separate wireless networking interface card.

### FIELD OF THE INVENTION

The present invention relates generally to devices for wireless networking for portable computers, and more particularly to a device for connecting to an existing networking connection of a portable computer and converting the networking signal into a different format for allowing wireless networking connectivity of the portable computer.

### BACKGROUND OF THE INVENTION

Airline passengers and crew are frequently bringing onboard aircraft computing devices including laptop computers and personal digital assistants (PDA). Many of these computing devices have some capacity to connect to a network for the sharing of resources and files. Therefore, it would be advantageous to allow connectivity to an onboard network for accessing and sharing resources and files.

The computing devices that connect to a network, however, can have different protocols for connecting to the network requiring different hardware and software in order to connect to the network. Further, many of these computing devices use a wired connection to a network rather than a wireless connection. There are several limitations to wired network connectivity that makes it impractical within an aircraft. A wired network requires considerable cabling connecting each of the nodes of the network to the server. This added weight and complexity to the existing aircraft wiring system is highly undesirable. A wired network would also require physically connecting each of the computing devices to the network. In an onboard aircraft environment this could cause difficulty in the movement of passengers trying to avoid exposed cabling.

For these reasons a wireless network connection provides significant advantages over a wired connection. However, connectivity problems arise in implementing a wireless network. First, few computing devices are equipped with the hardware necessary to enable wireless connectivity. Second, there are different wireless standards or protocols necessitating different equipment in order to function properly. Third, not all wireless connectivity solutions conform to Federal Aviation Association (FAA) requirements for use onboard a commercial aircraft. Therefore, current wireless connectivity solutions without modification are not adequate to meet the requirements of an onboard aircraft wireless network.

Therefore, there is a need for wireless network connectivity apparatus for allowing airline passengers and crew to connect their computing devices to an onboard wireless network. The apparatus should allow various portable computing devices with preexisting wired networking connectors to connect to the wireless network without the installation of any additional hardware or software being required on the portable computing devices(s).

### SUMMARY OF THE INVENTION

According to a preferred embodiment of the present invention there is provided a portable external wireless connectivity apparatus used to connect a portable computing device to a wireless network. Two-way data is exchanged between the wireless connectivity apparatus and the user's portable computing device via industry standard data interfaces. This includes Ethernet and Universal Serial Bus (USB) interfaces. The preferred embodiment includes a connector interface with an attachment for connecting the wireless connectivity apparatus to the portable computing device. The wireless connectivity apparatus connects to a pre-existing network interface connector installed in the computing device. The connector interface receives a networking signal from the computing device and converts the signal in a conversion module into a second signal that is transmitted to a wireless networking card connected to the wireless connectivity apparatus. The wireless networking card then transmits a wireless networking signal to the wireless network.

In the first preferred embodiment power is supplied to the components of the wireless connectivity apparatus through a battery. The battery is capable of being connected to a charging device in order to recharge the battery.

In a second alternative preferred embodiment, the wireless connectivity apparatus receives power by connecting to a Universal Serial Bus (USB) of the computing device. Power circuitry within the wireless connectivity apparatus supplies power from the USB to a conversion module of the apparatus and to the wireless networking card.

In operation an airline passenger would bring onboard their computing device, such as a laptop computer, and receive from a flight attendant the wireless connectivity apparatus. The passenger would then connect the apparatus to a network connection such as a 10/100 Base T connection preexisting in the user's computing device. The preexisting network connection may be from a PCMCIA card or from an internal networking interface. In one preferred form the user would also connect a second connector from the wireless connectivity apparatus to a USB port in the computing device for providing power to the apparatus. With the apparatus installed, the user will have access to a wireless network onboard the aircraft.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a laptop computer as an exemplary computing device with the wireless connectivity apparatus of the present invention attached thereto;

FIG. 2 is a simplified block diagram of the apparatus of FIG. 1 illustrating a first preferred embodiment thereof including a battery;

FIG. 3 is a simplified block diagram of a second alternative preferred embodiment of the apparatus with a power source connected to the USB port of the computing device of FIG. 1; and

FIG. 4 is a simplified block diagram of a third alternative preferred embodiment of the apparatus of FIG. 1 with circuitry for connecting the computing device to a wireless network.

### DETAILED DESCRIPTION OF THE PREFERRED EMBODIMENTS

The following description of the preferred embodiment(s) is merely exemplary in nature and is in no way intended to limit the invention, its application, or uses.

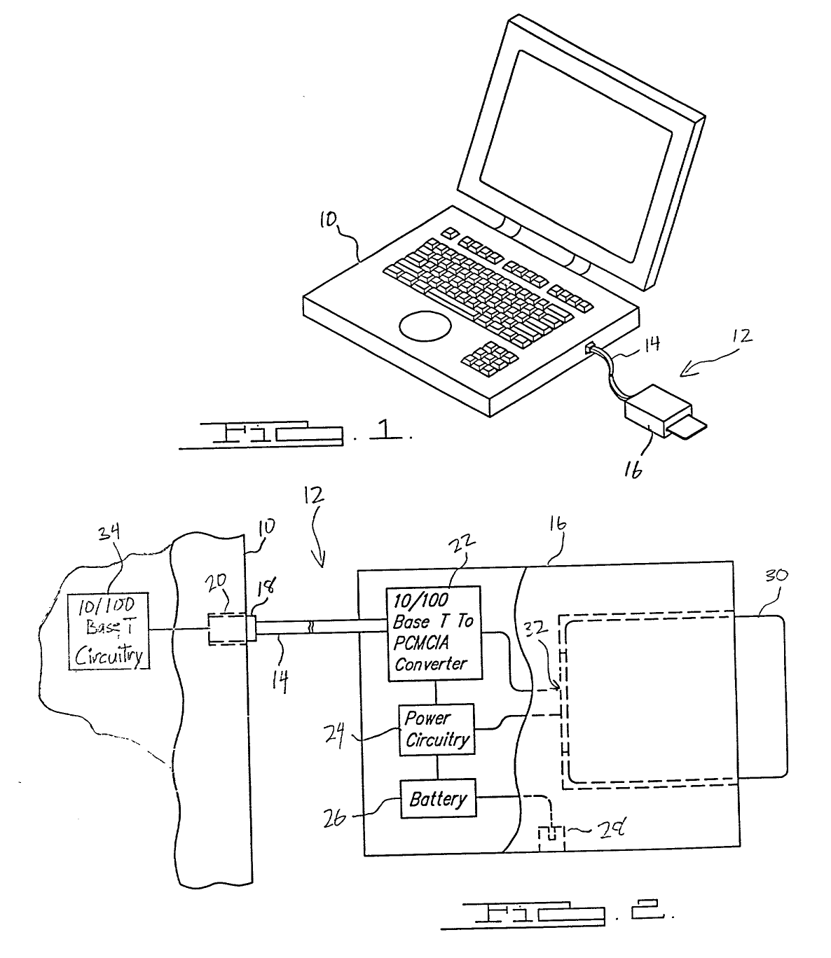

In FIG. 1, a computing device 10 with an attached wireless connectivity apparatus 12 in accordance with a preferred embodiment of the present invention is shown. It will be appreciated immediately that while the computing device 10 is illustrated as portable laptop computer, that the invention can be used with virtually any portable computing or digital device, and therefore should not be construed as being limited to use with only a laptop computer.

The wireless connectivity apparatus 12 includes a housing 16 with an attached connector or interface cable 14 for connecting the apparatus to the computing device 10.

Referring to FIG. 2, the apparatus 12 includes a coupler 18 attached to the connector cable 14 for connecting the apparatus to the computing device 10. The coupler 18 connects to a network port 20 disposed within the computing device 10. The network port 20 is connected to 10/100 Base T circuitry 34 also disposed within the computing device 10. While the 10/100 Base T circuitry 34 is illustrated as integrated within the computing device 10, it should be understood that the circuitry 34 is not limited to being integrated within the computing device 10. The 10/100 Base T circuitry 34 may be disposed in a networking interface card connected to the computing device 10 such as can be found in network interface cards connected to a Personal Computer Memory Card (PCMCIA) interface in the computing device10.

Disposed within the housing 16 of the wireless connectivity apparatus 12 is a 10/100 Base T-to-PCMCIA converter 22. The 10/100 Base T-to-PCMCIA converter 22 receives a networking signal from the 10/100 Base T circuitry 34 and converts it to the appropriate protocol for transmittal to a PCMCIA connector port 32. Connected to the PCMCIA connector port 32 is a wireless networking interface card 30. The wireless networking interface card 30 is of a suitable type to connect to a wireless network integrated into a commercial aircraft. The wireless networking interface card 30 receives power from a conventional power circuit 24. Power circuit 24 also supplies power to the 10/100 Base T-to-PCMCIA converter. Power circuit 24 is connected to a power source, in this case, a battery 26. Battery 26 can be recharged through a charging connector 28.

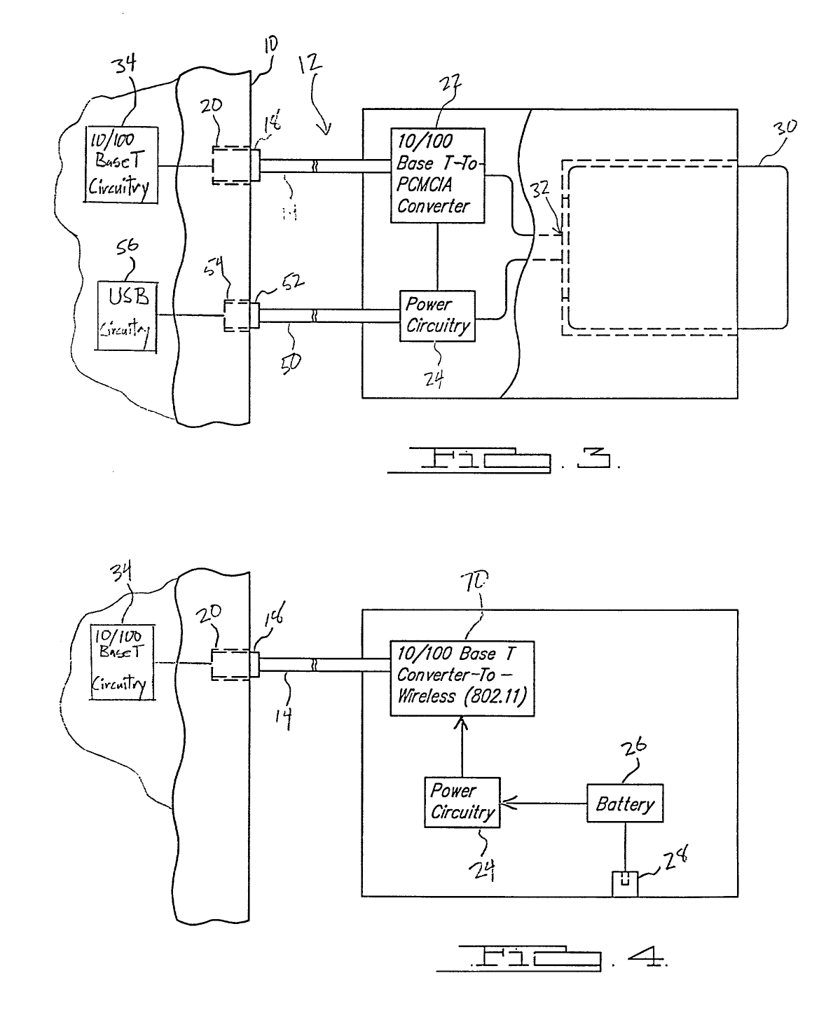

Referring now to FIG. 3, a second preferred embodiment of the wireless connectivity apparatus 12 is illustrated. A Universal Serial Bus (USB) connector cable 50 connects apparatus 12 to the computing device 10 through a USB coupler 52 engaged in a USB port 54 disposed in the computing device 10 housing. USB circuitry 56 disposed within the computing device 10 is connected to the USB port 54. The USB circuitry 56 is used in the second preferred embodiment to provide a power source to the power circuitry 24 disposed within the wireless connectivity device 12.

It should be appreciated that the USB port 54 and USB circuitry 56 can be used to provide both network connectivity and power to the wireless network interface card 30 if the computing device 10 is configured to use the USB port 54 for network connectivity.

Now referring to FIG. 4, a third preferred embodiment of the wireless connectivity apparatus 12 is illustrated. A 10/100 Base T converter-to-wireless (802.11 standard) module 70 receives a networking signal from the 10/100 T base circuitry 34 of the computing device 10 and converts it to a wireless local area networking technology standard such as 802.11b.

The preferred embodiments of the present invention thus provide a means to quickly and easily interface a user's portable electronic computing or digital device to an onboard wireless network within an aircraft without requiring disassembly of the user's device, and further without requiring the loading of software onto the user's device. The apparatus of the present invention is compact, light-weight, and can easily be distributed to passengers and/or crew members when they board an aircraft, and easily detached from the user's device and connected as passengers and/or crew deplane an aircraft. In addition, the apparatus forms a relatively low cost means which does not require numerous or bulky wiring harnesses to interface it with the user's device.

It will also be appreciated that the apparatus could be implemented on virtually any vehicle, or at any location, where one or more individuals would benefit from the convenience of being able to interface their computing device with a wireless network.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A wireless connectivity apparatus for connecting a computing device of an individual to a wireless network, wherein the wireless connectivity apparatus connects the computing device to the wireless network without first requiring modification to the hardware of the computing device, the apparatus comprising:
a first connector interface cable comprising a connector for connecting the apparatus to the computing device wherein the connector interface cable connects to a networking interface circuit of the computing device for receiving a first networking signal from the computing device, wherein the networking interface circuit is predisposed in the computing device;
a conversion module for receiving the first networking signal from the connector interface cable and converting the first networking signal into a second networking signal; and
a wireless networking interface card in communication with said conversion module for interfacing the second networking signal with said wireless network, to thereby interface said computing device to said wireless network.

2. The wireless connectivity apparatus of claim 1 further comprising:
a connector interface port for receiving said wireless networking interface card, wherein the second connector interface port receives the second networking signal and sends the second networking signal to the wireless networking interface card.

3. The wireless connectivity apparatus of claim 1 further comprising:
a power source connected to the conversion module for providing power to the conversion module.

4. The wireless connectivity apparatus of claim 2 further comprising:
a power source connected to the conversion module and to the second connector interface port for providing power to the conversion module and to the wireless networking interface card.

5. The wireless connectivity apparatus of claim 3, wherein the power source is a battery disposed within a housing of the apparatus.

6. The wireless connectivity apparatus of claim 1, wherein the wireless networking interface card comprises an industry standard specification for the wireless network.

7. A method for providing wireless network connectivity on a mobile platform, wherein an individual on the mobile platform is able to connect their computing device to the wireless network without modification to hardware within their computing devices, comprising the steps of:
placing the computing device in connection to the wireless network wherein the computing device has disposed within its housing a network interface for connecting the computing device to a wired network; and
connecting the network interface of the computing device to a wireless connectivity device wherein the wireless connectivity device connects the portable computer to the wireless network.

8. The method of claim 7 further comprising:
providing power to the wireless connectivity device through a rechargeable battery cell disposed within the wireless connectivity device.

9. The method of claim 8 further comprising:
providing power to the wireless connectivity device through a second connection between the computing device and the wireless connectivity device wherein the second connection is to a universal serial bus disposed in the computing device.

10. A method of providing wireless network connectivity to a computer predisposed with a wired network interface, comprising:
providing a wireless connectivity device with a wireless networking card disposed within, wherein the wireless connectivity device converts the networking signal of the wired network interface into a standardized second networking signal;
connecting the wired network interface of the computer to the wireless connectivity device wherein the wireless connectivity device is in communication with a wireless network base station.

11. A method for providing wireless network connectivity on a mobile platform to a portable computing device of an individual, wherein the computing device includes a network interface circuit, the method comprising the steps of:
providing an independent apparatus having a circuit for converting signals output from a network port of said computing device, from a first format into a second format suitable for use with an existing wireless network;
using a cable to interface said apparatus to said network port of said computing device; and
using a network card operably associated with said independent apparatus for receiving said signals in said second format and transmitting said signals to said wireless network.
